(19) United States
(12) Patent Application Publication
(10) Pub. No.: US 2022/0415071 A1
(43) Pub. Date: Dec. 29, 2022

(54) TRAINING METHOD OF TEXT RECOGNITION MODEL, TEXT RECOGNITION METHOD, AND APPARATUS

(71) Applicant: BEIJING BAIDU NETCOM SCIENCE TECHNOLOGY CO., LTD., Beijing (CN)

(72) Inventors: Chengquan ZHANG, Beijing (CN); Pengyuan LV, Beijing (CN); Shanshan LIU, Beijing (CN); Meina QIAO, Beijing (CN); Yangliu XU, Beijing (CN); Liang WU, Beijing (CN); Jingtuo LIU, Beijing (CN); Junyu HAN, Beijing (CN); Errui DING, Beijing (CN); Jingdong WANG, Beijing (CN)

(73) Assignee: BEIJING BAIDU NETCOM SCIENCE TECHNOLOGY CO., LTD., Beijing (CN)

(21) Appl. No.: 17/899,712

(22) Filed: Aug. 31, 2022

(30) Foreign Application Priority Data
Mar. 21, 2022 (CN) 2022102752784

(51) Int. Cl. G06V 30/19; G06V 30/18; G06T 9/00; G06V 30/262; G06N 20/00

(52) U.S. Cl. CPC G06V 30/19147; G06V 30/1916; G06V 30/18; G06T 9/00; G06V 30/274; G06N 20/00

(57) ABSTRACT

The present disclosure provides a training method of a text recognition model, a text recognition method, and an apparatus, relating to the technical field of artificial intelligence, and specifically, to the technical field of deep learning and computer vision, which can be applied in scenarios such as optional character recognition, etc. The specific implementation solution is: performing mask prediction on visual features of an acquired sample image, to obtain a predicted visual feature; performing mask prediction on semantic features of acquired sample text, to obtain a predicted semantic feature, where the sample image includes text; determining a first loss value of the text of the sample image according to the predicted visual feature; determining a second loss value of the sample text according to the predicted semantic feature; training, according to the first loss value and the second loss value, to obtain the text recognition model.

### CROSS-REFERENCE TO RELATED APPLICATION

This application claims priority to Chinese Patent Application No. 202210275278.4, filed on Mar. 21, 2022, which is hereby incorporated by reference in its entirety.

### TECHNICAL FIELD

The present disclosure relates to the technical field of artificial intelligence (AI), and specifically, to the technical field of deep learning and computer vision, which can be applied to scenarios such as optical character recognition (OCR), etc., and in particular, to a training method of a text recognition model, a text recognition method, and an apparatus.

### BACKGROUND

OCR technology has gained wide attention and has been widely used in various industries such as education, finance, medical treatment, transportation and insurance, etc.

In related technologies, OCR technology and deep learning can be combined to build a text recognition model, so as to perform text recognition to images based on the text recognition model.

However, text recognition models usually rely on visual information to identify the text content in images based on the visual information, which has the disadvantage of low recognition accuracy.

### SUMMARY

The present disclosure provides a training method of a text recognition model, a text recognition method, and an apparatus.

According to a first aspect of the present disclosure, a training method of a text recognition model is provided, including:

performing mask prediction on visual features of an acquired sample image to obtain a predicted visual feature, and performing mask prediction on semantic features of acquired sample text to obtain a predicted semantic feature, where the sample image includes text;

determining a first loss value of the text of the sample image according to the predicted visual feature, and determining a second loss value of the sample text according to the predicted semantic feature; and

training, according to the first loss value and the second loss value, to obtain the text recognition model, where the text recognition model is used to perform text recognition on at least one of text to be recognized and an image to be recognized.

According to a second aspect of the present disclosure, a text recognition method is provided, including:

acquiring an object to be recognized, where the object to be recognized includes text, and the object to be recognized is an image to be recognized or text to be recognized; and

performing text recognition on the object to be recognized based on a pre-trained text recognition model, to obtain text content corresponding to the object to be recognized;

where the text recognition model is obtained based on the method according to the first aspect.

According to a third aspect of the present disclosure, a training apparatus of a text recognition model is provided, including:

at least one processor; and

a memory communicatively connected to the at least one processor; where

the memory stores an instruction executable by the at least one processor, and the instruction, when executed by the at least one processor, causes the at least one processor to:

perform mask prediction on visual features of an acquired sample image to obtain a predicted visual feature, where the sample image includes text;

perform mask prediction on semantic features of acquired sample text to obtain a predicted semantic feature;

determine a first loss value of the text of the sample image according to the predicted visual feature;

determine a second loss value of the sample text according to the predicted semantic feature; and

train, according to the first loss value and the second loss value, to obtain the text recognition model, where the text recognition model is used to perform text recognition on at least one of text to be recognized and an image to be recognized.

According to a fourth aspect of the present disclosure, a text recognition apparatus is provided, including:

at least one processor; and

a memory communicatively connected to the at least one processor; where

the memory stores an instruction executable by the at least one processor, and the instruction, when executed by the at least one processor, causes the at least one processor to:

acquire an object to be recognized, where the object to be recognized includes text, and the object to be recognized is an image to be recognized or text to be recognized; and

perform text recognition on the object to be recognized based on a pre-trained text recognition model, to obtain text content corresponding to the object to be recognized;

where the text recognition model is obtained based on the method according to the first aspect.

According to a fifth aspect of the present disclosure, a non-transitory computer-readable storage medium storing a computer instruction is provided, where the computer instruction is used to cause a computer to execute the method according to the first aspect or the second aspect.

It should be understood that the content described in this section is not intended to identify key or important features of the embodiments of the present disclosure, nor is it intended to limit the scope of the present disclosure. Other features of the present disclosure will be readily understood from the following description.

### BRIEF DESCRIPTION OF DRAWINGS

The drawings are used for a better understanding of the present solution, and do not constitute a limitation of the present disclosure.

FIG. 1 is a schematic diagram according to a first embodiment of the present disclosure.

FIG. 2 is a schematic diagram according to a second embodiment of the present disclosure.

FIG. 3 is a schematic diagram according to a third embodiment of the present disclosure.

FIG. 4 is a schematic principle diagram of a training method for a text recognition model of the present disclosure.

FIG. 5 is a schematic diagram according to a fourth embodiment of the present disclosure.

FIG. 6 is a schematic diagram according to a fifth embodiment of the present disclosure.

FIG. 7 is a schematic diagram according to a sixth embodiment of the present disclosure.

FIG. 8 is a schematic diagram according to a seventh embodiment of the present disclosure.

FIG. 9 is a schematic diagram according to an eighth embodiment of the present disclosure.

FIG. 10 is a block diagram of an electronic device for implementing the training method for the text recognition model and the text recognition method of the present disclosure.

### DESCRIPTION OF EMBODIMENTS

Exemplary embodiments of the present disclosure are described below with reference to the accompanying drawings, including various details of the embodiments of the present disclosure to facilitate understanding, which should be regarded as merely illustrative. Therefore, those skilled in the art should realize that various changes and modifications can be made to the embodiments described herein without departing from the scope and spirit of the present disclosure. Similarly, for clarity and conciseness, the description of well-known functions and structures is omitted in the following description.

In some embodiments, a method for training a text recognition model includes: acquiring a sample image, where the sample image includes text, and training, based on the sample image, to obtain the text recognition model.

Illustratively, a preset basic network is trained based on the sample image, for example, a model parameter of the basic network is adjusted based on the sample image to obtain the text recognition model.

For example, the basic network can be trained according to visual information of the sample image, to obtain the text recognition model.

Illustratively, feature-extraction is performed on the sample image to obtain visual features of the sample image, and the basic network is trained based on the visual features, so as to enable the basic network to learn the ability of extracting text content based on the visual features, thereby obtaining the text recognition model.

The visual features refer to features of the sample image in a visual dimension, such as texture and color.

In some other embodiments, a method for training a text recognition model includes: acquiring sample text, and training, based on the sample text, to obtain the text recognition model.

Illustratively, a preset basic network is trained based on the sample text, for example, a model parameter of the basic network is adjusted based on the sample text to obtain the text recognition model.

For example, the basic network can be trained according to semantic information of the sample text, to obtain the text recognition model.

Illustratively, feature-extraction is performed on the sample text to obtain semantic features of the sample text, and the basic network is trained based on the semantic features, so as to enable the basic network to learn the ability of extracting text content based on the semantic features, thereby obtaining the text recognition model.

The semantic features refer to features of logic relationships among respective character strings of the sample text.

However, adopting the text recognition model based on visual feature training or semantic feature training in the above embodiments may make the dimension of recognition of the text recognition model single, such as the dimension of recognition of the text recognition model obtained by training based on visual features is visual information, and the dimension of recognition of the text recognition model obtained by training based on text features is text information, which leads to the disadvantage of low recognition accuracy when the text recognition model is used for text recognition.

In order to avoid at least one of the above problems, the inventor of the present disclosure got the inventive concept of the present disclosure by making creative efforts: training a text recognition model from two dimensions of visual features and semantic features, and the training process shares parameters (such as loss values) corresponding to the two dimensions.

Based on the above inventive concept, the present disclosure provides a training method of a text recognition model, a text recognition method, and an apparatus, applied in the technical field of deep learning and computer vision in the artificial intelligence field, which can be applied in scenarios such as OCR, etc., so as to improve the reliability of the text recognition.

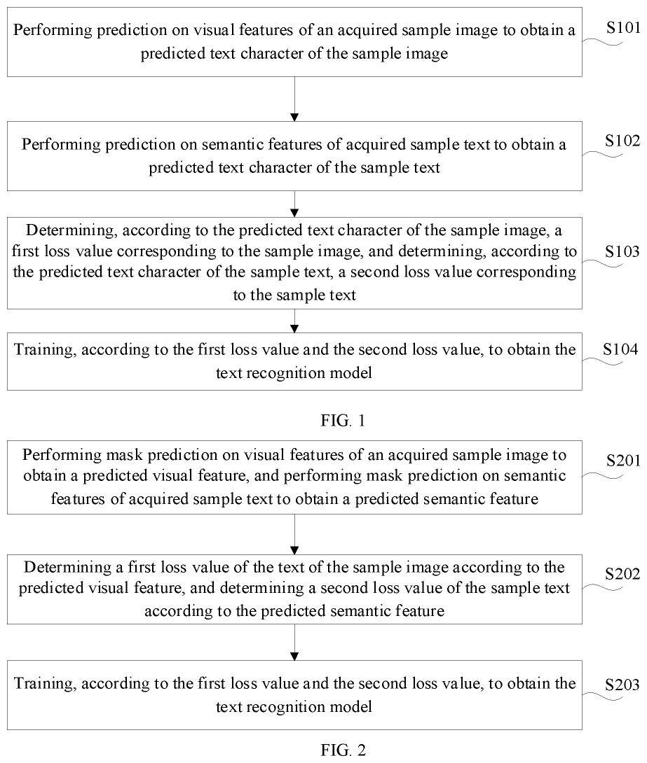

FIG. 1 is a schematic diagram according to a first embodiment of the present disclosure. As shown in FIG. 1, a training method of a text recognition model of an embodiment of the present disclosure includes:

S101: performing prediction on visual features of an acquired sample image to obtain a predicted text character of the sample image.

The sample image includes text.

Illustratively, an executive subject of the present embodiment may be a training apparatus of the text recognition model (hereinafter referred to as training apparatus), and the training apparatus may be a server (such as a cloud server, or a local server, or a server cluster), a terminal device, a computer, a processor, or a chip etc., which is not limited by the present embodiment.

This step can be understood as: acquiring the sample image including text, and performing feature extraction on the sample image to obtain the visual features of the sample image, and specifically, the visual features of the text in the sample image, such as texture features, contour features, color features or shape features, etc., which will not be listed one by one here.

In the present embodiment, the manner of predicting the text of the sample image based on the visual features to obtain the predicted text character is not limited, for example, it can be implemented based on a coder.

S102: performing prediction on semantic features of acquired sample text to obtain a predicted text character of the sample text.

Similarly, this step could be understood as: acquiring the sample text, where the sample text may be sample text corresponding to the sample image (for example, text included in the sample image), or may be sample text that is different from the text in the sample image; performing feature extraction on the sample text to obtain semantic features of the sample text, specifically the semantic features of the text in the sample text, for example, logic relationships among respective character strings in the text.

Similarly, in the present embodiment, the manner of predicting the text of the sample text based on the semantic features to obtain the predicted text character is not limited, for example, it can be implemented based on a coder.

S103: determining, according to the predicted text character of the sample image, a first loss value corresponding to the sample image, and determining, according to the predicted text character of the sample text, a second loss value corresponding to the sample text.

The first loss value can be understood as difference information between a real text character and the predicted text character of the sample image. The second loss value can be understood as difference information between a real text character and the predicted text character of the sample text.

S104: training, according to the first loss value and the second loss value, to obtain the text recognition model.

The text recognition model is used to perform text recognition on at least one of text to be recognized and an image to be recognized.

That is, in the present embodiment, by sharing parameters (i.e. the first loss value and the second loss value) trained in two dimensions of the visual features and the semantic features, the text recognition model is enabled to not only mine visual information, but also mine semantic context logic, so that when text recognition is performed based on the text recognition model, diversity and comprehensiveness of the text recognition can be improved.

Based on the above analysis, the embodiment of the present disclosure provides a training method of a text recognition model, including: performing prediction on visual features of an acquired sample image to obtain a predicted text character of the sample image, where the sample image includes text; performing prediction on semantic features of acquired sample text to obtain a predicted text character of the sample text; determining a first loss value corresponding to the sample image according to the predicted text character of the sample image, determining a second loss value corresponding to the sample text according to the predicted text character of the sample text, and training, according to the first loss value and the second loss value, to obtain the text recognition model, where the text recognition model is used for text recognition of at least one of a text to be recognized and an image to be recognized. In the present embodiment, by determining the first loss value corresponding to the sample image and the second loss value corresponding to the sample text, the text recognition model is obtained through training by sharing the first loss value and the second loss value, thus avoiding the disadvantage of low reliability caused by training the text recognition model based on a single feature dimension (such as the visual feature dimension or the semantic feature dimension), thereby improving the comprehensiveness and diversity of training, and achieving the technical effect of improving the accuracy and reliability of the text recognition performed by the text recognition model.

FIG. 2 is a schematic diagram according to a second embodiment of the present disclosure. As shown in FIG. 2, a training method of a text recognition model of an embodiment of the present disclosure includes:

S201: performing mask prediction on visual features of an acquired sample image to obtain a predicted visual feature, and performing mask prediction on semantic features of acquired sample text to obtain a predicted semantic feature.

The sample image includes text.

It should be understood that, in order to avoid complicated statements, the technical features of the present embodiment which are the same as those of the above-mentioned embodiments will not be described in detail in the present embodiment.

Mask prediction of the visual features can also be called shade processing of the visual features, which can be understood as performing a mask operation (or covering operation) on some visual features for predicting the visual feature (i.e. predicted visual feature) of the covered part.

Similarly, mask prediction of the semantic features can also be called shade processing of the semantic features, which can be understood as performing a mask operation (or covering operation) of some semantic features for predicting the semantic feature (i.e. predicted semantic feature) of the covered part.

S202, determining a first loss value of the text of the sample image according to the predicted visual feature, and determining a second loss value of the sample text according to the predicted semantic feature.

S203: training, according to the first loss value and the second loss value, to obtain the text recognition model.

The text recognition model is used to perform text recognition on at least one of text to be recognized and an image to be recognized.

Similarly, in the present embodiment, by sharing parameters (i.e. the first loss value and the second loss value) trained in two dimensions of the visual features and the semantic features, the text recognition model is enabled to not only mine visual information, but also mine semantic context logic, so that when text recognition is performed based on the text recognition model, diversity and comprehensiveness of the text recognition can be improved.

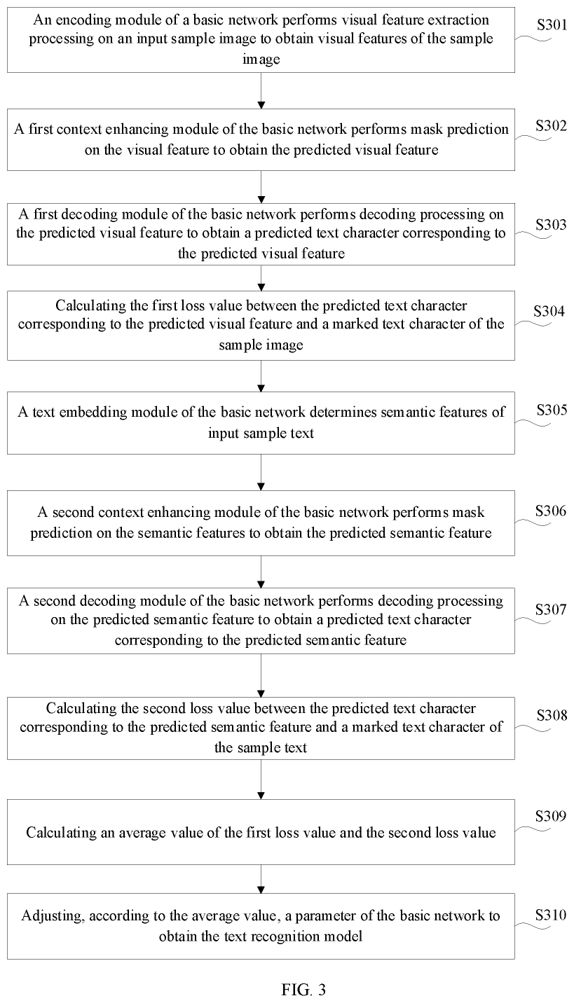

In order for readers to have a deeper understanding of the implementation principle of the present disclosure, the above-mentioned embodiments (at least one embodiment as shown in FIG. 1 and FIG. 2) are further described with reference to FIG. 3.

FIG. 3 is a schematic diagram according to a third embodiment of the present disclosure. As shown in FIG. 3, a training method of a text recognition model of an embodiment of the present disclosure includes:

S301: an encoding module of a basic network performs visual feature extraction processing on an input sample image to obtain visual features of the sample image.

The sample image includes text. The visual features are specifically features of text in the sample image in vision.

Similarly, in order to avoid complicated statements, the technical features of the present embodiment which are the same as those of the above-mentioned embodiments will not be described in detail in the present embodiment.

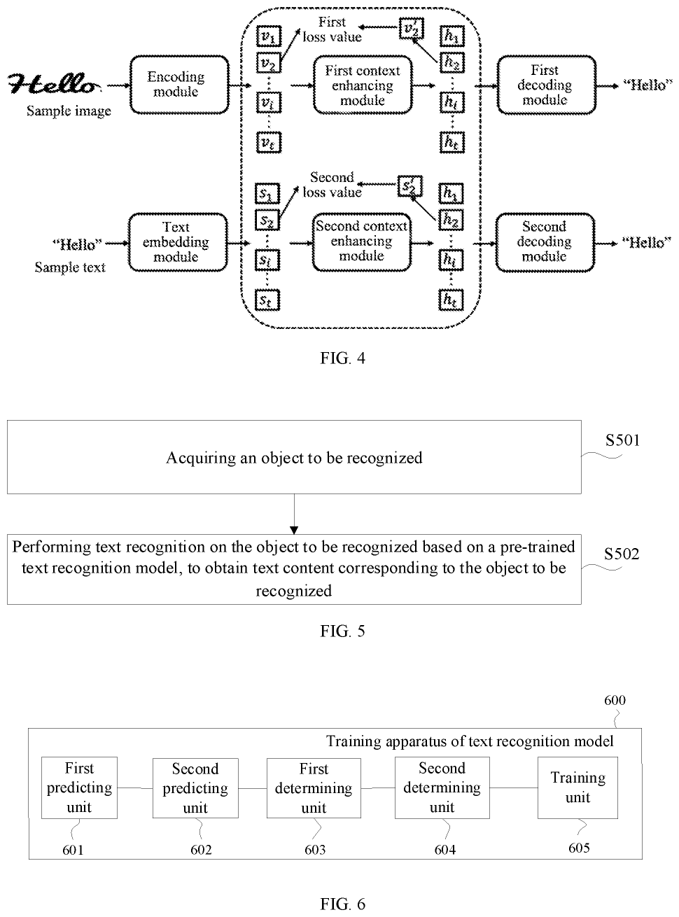

According to the above analysis, the training of the text recognition model can be implemented on the basic network. In the present embodiment, the basic network includes an encoding module, such as a first coding module and the second coding module as shown in FIG. 4. The sample image is an image including text “hello” as shown in FIG. 4.

The structure of the encoding module is not limited by the present embodiment. For example, the encoding module can be a convolutional neural network (CNN) structure, a vision transformer (ViT) structure, or a transformer structure, etc.

S302: a first context enhancing module of the basic network performs mask prediction on the visual feature to obtain the predicted visual feature.

Similarly, the basic network includes the first context enhancing module. It should be understood that the word “first” in the first context enhancing module is used for distinction from the second context enhancing module in the following, but it cannot be understood as the limitation of the first context enhancing module.

The context enhancing module can be used to enhance the mutual reasoning ability between input feature sequences, and the structure of the context enhancing module can be a recurrent neural network (RNN) structure or a Transformer structure, etc., which is not limited by the present embodiment.

Illustratively, the basic network includes a context enhancing module. As shown in FIG. 4, the basic network may include two context enhancing modules. The context enhancing module for processing visual features may be the first context enhancing module as shown in FIG. 4, and the context enhancing module for processing semantic features may be the second context enhancing module as shown in FIG. 4.

That is, as shown in FIG. 4, the context enhancing module in the upper part is the first context enhancing module, and the context enhancing module in the lower part is the second context enhancing module.

Accordingly, in the present embodiment, the first context enhancing module can be used to enhance the mutual reasoning ability between visual features, for example, reasoning from some visual features to get other visual features. And the structure of the first context enhancing module may be an RNN structure, or a Transformer structure, etc.

A mask feature modeling can be introduced into the context enhancing module, so that the context enhancing module can enhance the context understanding of the input features with the mask feature modeling being used for input and a feature prediction being used for output.

Illustratively, in the present embodiment, the mask feature modeling can be introduced into the first context enhancing module, and the mask feature modeling can perform mask prediction on the visual features to obtain the predicted visual feature.

The mask feature modeling may be a masked language model (MLM), a masked quantitative prediction (wav2vec 2.0), a masked image reconstruction (Masked Autoencoder, MAE), etc.

It should be understood that the number of context enhancing modules in FIG. 4 is only for illustrative description, and in other embodiments, the number of context enhancing modules may be one, and in other embodiments, the number of context enhancing modules may be more.

S303: a first decoding module of the basic network performs decoding processing on the predicted visual feature to obtain a predicted text character corresponding to the predicted visual feature.

Similarly, the word “first” in the first decoding module in the present embodiment is used for distinction from the second decoding module in the following, but it cannot be understood as the limitation of the first decoding module.

The decoding mode of the decoding module is not limited by the present embodiment. For example, the decoding mode of the decoding module can be a connectionist temporal classification (CTC) decoding mode, an attention decoding mode, a transformer decoder decoding mode, etc.

Illustratively, the decoding mode of the first decoding module can be the CTC decoding mode, and as shown in FIG. 4, FIG. 4 includes two decoding modules, correspondingly, the decoding module shown in the upper part of FIG. 4 can be the first decoding module.

S304: calculating the first loss value between the predicted text character corresponding to the predicted visual feature and a marked text character of the sample image.

Illustratively, the step can be understood as: acquiring the marked text character of the sample image; calculating, according to the predicted text character corresponding to the predicted visual feature and the marked text character of the sample image, to obtain a loss value of the text in the sample image (i.e. the first loss value).

The marked text character of the sample image can be understood as a real text character of the sample image, which can be marked manually or automatically, which is not limited by the present embodiment.

Illustratively, as shown in FIG. 4, υ₁, υ₂, υᵢ to υₜ represent marked text characters of the sample image, h₁, h₂, hᵢ to hₜ represent predicted visual features of the sample image, and υ′₂ represents a predicted text character corresponding to the predicted visual feature h₂.

As shown in FIG. 4, the loss value (similarity loss) between υ₂ and υ′₂ is calculated to obtain the first loss value as shown in FIG. 4.

In the present embodiment, by decoding the predicted visual feature, the predicted text character corresponding to the predicted visual feature is obtained, and the first loss value is determined according to the predicted text character corresponding to the predicted visual feature, so that the first loss value can accurately represent the loss value corresponding to the text of the sample image, so that the text recognition model obtained by training can learn a strong reasoning ability between visual feature dimensions, thereby improving the accuracy of the text recognition model.

Preferably, the first loss value is determined by combining the marked text character of the sample image with the predicted text character corresponding to the predicted visual feature. As the marked text character of the sample image represents the real text character in the sample image, the calculated first loss value can be made to have high authenticity and reliable pertinence.

S305: a text embedding module of the basic network determines semantic features of input sample text.

The text embedding module can determine the semantic features based on an encoding manner of one-hot encoding or an encoding manner of word2vec coding, or even a manner of a learnable embedding module. As shown in FIG. 4, the sample text including the text “hello” can be input into the text embedding module to obtain the semantic features of the sample text.

S306: a second context enhancing module of the basic network performs mask prediction on the semantic features to obtain a predicted semantic feature.

For the implementation principle of the second context enhancing module, reference can be made to the description of the first context enhancing module, which will not be repeated here.

Referring to the above analysis, FIG. 4 includes two context enhancing modules, where the context enhancing module in the lower part is the second context enhancing module.

S307: a second decoding module of the basic network performs decoding processing on the predicted semantic feature to obtain a predicted text character corresponding to the predicted semantic feature.

Referring to the above analysis, FIG. 4 includes two decoding modules, where the decoding module in the lower part is the second decoding module as shown in FIG. 4.

S308: calculating the second loss value between the predicted text character corresponding to the predicted semantic feature and a marked text character of the sample text.

Illustratively, the step can be understood as: acquiring the marked text character of the sample text; calculating, according to the predicted text character corresponding to the predicted semantic feature and the marked text character of the sample text, to obtain a loss value of the text in the sample text (i.e. the second loss value).

The marked text character of the sample text can be understood as a real text character of the sample text, which can be marked manually or automatically, which is not limited by the present embodiment.

Illustratively, as shown in FIG. 4, s₁, s₂, sᵢ to sₜ represent marked text characters of the sample text, h₁, h₂, hᵢ to hₜ represent predicted semantic features of the sample text, and s′₂ represents a predicted text character corresponding to the predicted semantic feature h₂.

As shown in FIG. 4, the loss value between s₂ and s′₂ is calculated to obtain the second loss value as shown in FIG. 4.

In the present embodiment, by decoding the predicted semantic feature, the predicted text character corresponding to the predicted semantic feature is obtained, and the second loss value is determined according to the predicted text character corresponding to the predicted semantic feature, so that the second loss value can accurately represent the loss value corresponding to the sample text, so that the text recognition model obtained by training can learn a strong reasoning ability between semantic feature dimensions, thereby improving the accuracy of the text recognition model.

Preferably, the second loss value is determined by combining the marked text character of the sample text with the predicted text character corresponding to the predicted semantic feature. As the marked text character of the sample text represents the real text character in the sample text, the calculated second loss value can be made to have high authenticity and reliable pertinence.

S309: calculating an average value of the first loss value and the second loss value.

S310: adjusting, according to the average value, a parameter of the basic network to obtain the text recognition model.

The text recognition model is used to perform text recognition on at least one of text to be recognized and an image to be recognized.

Illustratively, iterative training is performed on the basic network based on the average value to obtain the text recognition model.

For example, parameters of the encoding module, the context enhancing module (including the first context enhancing module and the second context enhancing module), the decoding module (including the first decoding module and the second decoding module) and the text embedding module are adjusted based on the average value, until the text output by the basic network model after being iteratively trained is the same as the real text (as shown in FIG. 4, the input text is “hello” and the output text is also “hello”), or the number of iterations reaches a preset threshold.

In the present embodiment, an average value of the first loss value and the second loss value is determined, so as to train according to the average value to obtain the text recognition model, and to implement training by sharing the first loss value and the second loss value to obtain the text recognition model, so that the text recognition model not only has a strong reasoning ability of the visual feature dimension, but also has a strong reasoning ability of the semantic feature dimension, thus improving the reliability and accuracy of text recognition of the text recognition model.

FIG. 5 is a schematic diagram according to a fourth embodiment of the present disclosure. As shown in FIG. 5, a text recognition method of an embodiment of the present disclosure includes:

S501: acquiring an object to be recognized.

The object to be recognized includes text, and the object to be recognized is an image to be recognized or text to be recognized.

Illustratively, the executive subject of the present embodiment may be a text recognition apparatus, where the text recognition apparatus may be an apparatus same or not same as a training apparatus, which is not limited by the present embodiment.

The acquiring the object to be recognized can be implemented by adopting the following examples.

In an example, the text recognition apparatus can be connected with an object acquisition apparatus (such as an image acquisition apparatus), and can receive the object to be recognized sent by the object acquisition apparatus.

In another example, the text recognition apparatus can provide a tool for loading the object to be recognized, and a user can transmit the object to be recognized to the text recognition apparatus through the tool for loading the object to be recognized.

The tool for loading the object to be recognized can be an interface for connecting with an external device, such as an interface for connecting with other storage devices, through which the object to be recognized transmitted by the external device can be acquired; the tool for loading the object to be recognized can also be a display apparatus, for example, a text recognition apparatus can input an interface for loading the object to be recognized on the display apparatus, and the user can import the object to be recognized into the text recognition apparatus through the interface.

S502: performing text recognition on the object to be recognized based on a pre-trained text recognition model, to obtain text content corresponding to the object to be recognized.

The text recognition model is obtained based on the training method of the text recognition model as described in any of the embodiments above.

In the present embodiment, the text recognition model trained by the above method is used to perform text recognition on the object to be recognized, so as to achieve the effects of visual context enhancement and semantic context enhancement, and the reasoning process does not bring additional calculation expense and cost to the text recognition model. The overall effect of OCR recognition products in challenging business scenarios is strengthened, and the experience of AI products is enhanced. The new text recognition method takes into account the self-supervised reconstruction of visual features to strengthen the visual context ability, and at the same time, it also shares the ability of masked text characters/words prediction to strengthen semantic context reasoning, which greatly improves the accuracy of the text recognition model. Accordingly, the vertical application technologies of OCR recognition products can be applied more widely, the development cost can be reduced, the accuracy can be guaranteed, and the vertical applicability can be increased, such as financial (such as text recognition of invoice images, etc.) scenarios, educational (such as text recognition of test paper images, etc.) scenarios, medical (such as text recognition of medical record images, etc.) scenarios, insurance (such as text recognition of insurance policy images, etc.) scenarios, office (such as text recognition of company financial report images, etc.) scenarios.

In some embodiments, if the object to be recognized is the image to be recognized, the performing text recognition on the object to be recognized based on the pre-trained text recognition model, to obtain text content corresponding to the object to be recognized includes the following steps:

Step 1: performing feature-extraction processing on the image to be recognized, to obtain visual features of the image to be recognized;

Step 2: performing, by adopting the text recognition model, text recognition on the image to be recognized according to the visual features of the image to be recognized, to obtain text content corresponding to the image to be recognized.

Illustratively, with reference to the above analysis, if the object to be recognized is an image to be recognized, the image to be recognized can be input into the encoding module of the text recognition model as shown in FIG. 4, and the encoding module performs encoding processing on the image to be recognized, to obtain the visual features of the image to be recognized, and the visual features of the image to be recognized are input into the context enhancing module of the text recognition model, such as the first context enhancing module or the second context enhancing module, the predicted visual feature with a strong reasoning ability of the visual feature dimension and a strong reasoning ability of the semantic feature dimension is output, and the visual feature is input into the decoding module of the text recognition model, such as the first decoding module or the second decoding module, to output the text content corresponding to the image to be recognized with high accuracy and reliability.

In some other embodiments, if the object to be recognized is the text to be recognized, the performing text recognition on the object to be recognized based on the pre-trained text recognition model, to obtain text content corresponding to the object to be recognized includes the following steps:

Step 1: performing feature-extraction processing on the text to be recognized, to obtain semantic features of the text to be recognized;

Step 2: performing, by adopting the text recognition model, text recognition on the text to be recognized according to the semantic features of the text to be recognized, to obtain text content corresponding to the text to be recognized.

Illustratively, with reference to the above analysis, if the object to be recognized is text to be recognized, the text to be recognized can be input into the text embedding module of the text recognition model as shown in FIG. 4, and the text embedding module performs text mapping processing on the text to be recognized, to obtain the semantic features of the text to be recognized, and the semantic features of the text to be recognized are input into the context enhancing module of the text recognition model, such as the first context enhancing module or the second context enhancing module, the predicted semantic feature with a strong reasoning ability of the visual feature dimension and a strong reasoning ability of the semantic feature dimension is output, and such semantic feature is input into the decoding module of the text recognition model, such as the first decoding module or the second decoding module, to output the text content corresponding to the text to be recognized with high accuracy and reliability.

That is, with reference to FIG. 4 and the above analysis, after the text recognition model is obtained by training, in order to facilitate the application of the text recognition model, some branches can be removed from the text recognition model, such as redundant context enhancing module and decoding module.

FIG. 6 is a schematic diagram according to a fifth embodiment of the present disclosure. As shown in FIG. 6, a training apparatus 600 of a text recognition model of an embodiment of the present disclosure includes:

a first predicting unit 601, configured to perform mask prediction on visual features of an acquired sample image to obtain a predicted visual feature, where the sample image includes text;

a second predicting unit 602, configured to perform mask prediction on semantic features of acquired sample text to obtain a predicted semantic feature;

a first determining unit 603, configured to determine a first loss value of the text of the sample image according to the predicted visual feature;

a second determining unit 604, configured to determine a second loss value of the sample text according to the predicted semantic feature; and

a training unit 605, configured to train, according to the first loss value and the second loss value, to obtain the text recognition model, where the text recognition model is used to perform text recognition on at least one of text to be recognized and an image to be recognized.

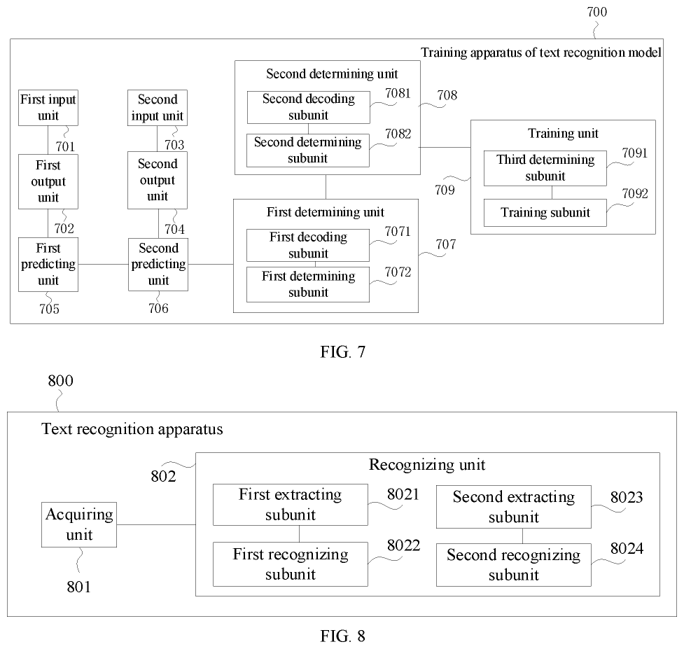

FIG. 7 is a schematic diagram according to a sixth embodiment of the present disclosure. As shown in FIG. 7, a training apparatus 700 of a text recognition model of an embodiment of the present disclosure includes:

a first input unit 701, configured to input an acquired sample image into an encoding module of a preset basic network;

a first output unit 702, configured to output visual features;

a second input unit 703, configured to input acquired sample text into a text embedding module of a preset basic network;

a second output unit 704, configured to output semantic features;

a first predicting unit 705, configured to perform mask prediction on the visual feature of the acquired sample image to obtain a predicted visual feature, where the sample image includes text;

a second predicting unit 706, configured to perform mask prediction on the semantic feature of the acquired sample text to obtain a predicted semantic feature; and

a first determining unit 707, configured to determine a first loss value of the text of the sample image according to the predicted visual feature.

It can be seen with reference to FIG. 7, in some embodiments, the first determining unit 707 includes:

a first decoding subunit 7071, configured to perform decoding processing on the predicted visual feature to obtain a predicted text character corresponding to the predicted visual feature; and

a first determining subunit 7072, configured to determine the first loss value according to the predicted text character corresponding to the predicted visual feature.

In some embodiments, the first determining subunit 7072 includes:

a first acquiring module, configured to acquire a marked text character of the sample image; and

a first computing module, configured to calculate, according to the predicted text character corresponding to the predicted visual feature and the marked text character of the sample image, to obtain the first loss value;

the second determining unit 708 is configured to determine a second loss value of the sample text according to the predicted semantic feature.

It can be seen with reference to FIG. 7, in some embodiments, the second determining unit 708 includes:

a second decoding subunit 7081, configured to perform decoding processing on the predicted semantic feature to obtain a predicted text character corresponding to the predicted semantic feature; and

a second determining subunit 7082, configured to determine the second loss value according to the predicted text character corresponding to the predicted semantic feature.

In some embodiments, the second determining subunit 7082 includes:

a second acquiring module, configured to acquire a marked text character of the sample text; and

a second computing module, configured to calculate, according to the predicted text character corresponding to the predicted semantic feature and the marked text character of the sample text, to obtain the second loss value;

the training unit 709 is configured to train, according to the first loss value and the second loss value, to obtain the text recognition model, where the text recognition model is used to perform text recognition on at least one of text to be recognized and an image to be recognized.

With reference to the above analysis, in some embodiments, the training unit 709 is configured to adjust a parameter of the encoding module according to the first loss value and the second loss value, to obtain the text recognition model.

With reference to the above analysis, in some embodiments, the training unit 709 is configured to adjust a parameter of the text embedding module according to the first loss value and the second loss value, to obtain the text recognition model.

It can be seen with reference to FIG. 7, in some embodiments, the training unit 709 includes:

a third determining subunit 7091, configured to determine an average value of the first loss value and the second loss value; and

a training subunit 7092, configured to train, according to the average value, to obtain the text recognition model.

In some embodiments, the training apparatus 700 of the text recognition model is applied to a preset basic network, and the basic network includes a context enhancing module and a decoding module.

The predicted visual feature is obtained by performing mask prediction on the visual features of the sample image based on the context enhancing module.

Illustratively, the first predicting unit 705 may be configured to perform mask prediction on the visual features of the acquired sample image based on the context enhancing module of the preset basic network, to obtain the predicted visual feature.

The first loss value is determined based on the predicted visual feature and the decoding module.

Illustratively, the first decoding subunit 7071 may be configured to perform decoding processing on the predicted visual feature based on a decoding module of the basic network, to obtain a predicted text character corresponding to the predicted visual feature, so as to determine the first loss value based on the predicted text character corresponding to the predicted visual feature.

The text recognition model is obtained by adjusting the parameter of the basic network based on the first loss value and the second loss value.

Illustratively, the training unit 709 may be configured to adjust the parameter of the basic network according to the first loss value and the second loss value, to obtain the text recognition model.

In some embodiments, the training apparatus 700 of the text recognition model is applied to a preset basic network, and the basic network includes a context enhancing module and an decoding module.

The predicted semantic feature is obtained by performing mask prediction on the semantic features of the sample text based on the context enhancing module.

Illustratively, the second predicting unit 706 may be configured to perform mask prediction on the semantic features of the acquired sample text based on the context enhancing module of the preset basic network, to obtain the predicted semantic feature.

The second loss value is obtained based on the predicted semantic feature and the decoding module.

Illustratively, the second decoding subunit 7081 may be configured to perform decoding processing on the predicted semantic feature based on a decoding module of the basic network, to obtain a predicted text character corresponding to the predicted semantic feature, so as to obtain the second loss value based on the predicted text character corresponding to the predicted semantic feature and the marked text character of the sample text.

The text recognition model is obtained by adjusting the parameter of the basic network based on the first loss value and the second loss value.

Illustratively, the training unit 709 may be configured to adjust the parameter of the basic network according to the first loss value and the second loss value, to obtain the text recognition model.

FIG. 8 is a schematic diagram according to a seventh embodiment of the present disclosure. As shown in FIG. 8, a text recognition apparatus of an embodiment of the present disclosure includes:

an acquiring unit 801, configured to acquire an object to be recognized, where the object to be recognized includes text, and the object to be recognized is an image to be recognized or text to be recognized; and

a recognizing unit 802, configured to perform text recognition on the object to be recognized based on a pre-trained text recognition model, to obtain text content corresponding to the object to be recognized;

the text recognition model is obtained based on the training method of the text recognition model as described in any of the embodiments above.

In some embodiments, the object to be recognized is the image to be recognized, and as shown in FIG. 8, the recognizing unit 802 includes:

a first extracting subunit 8021, configured to perform feature-extraction processing on the image to be recognized, to obtain visual features of the image to be recognized; and

a first recognizing subunit 8022, configured to perform, by adopting the text recognition model, text recognition on the image to be recognized according to the visual features of the image to be recognized, to obtain text content corresponding to the image to be recognized.

In some embodiments, the object to be recognized is the text to be recognized, and as shown in FIG. 8, the recognizing unit 802 includes:

a second extracting subunit 8023, configured to perform feature-extraction processing on the text to be recognized, to obtain semantic features of the text to be recognized; and

a second recognizing subunit 8024, configured to perform, by adopting the text recognition model, text recognition on the text to be recognized according to the semantic features of the text to be recognized, to obtain text content corresponding to the text to be recognized.

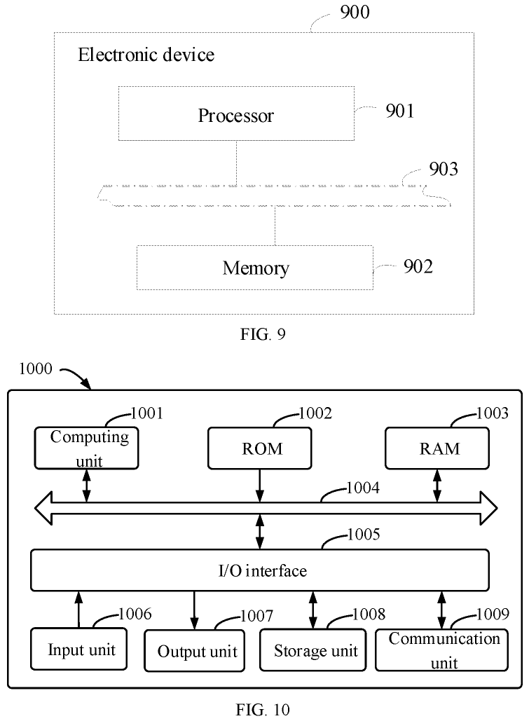

FIG. 9 is a schematic diagram according to an eighth embodiment of the present disclosure, and as shown in FIG. 9, an electronic device 900 of the present disclosure may include: a processor 901 and a memory 902.

The memory 902 is used for storing programs; the memory 902 may include a volatile memory, such as a random access memory (abbreviation: RAM), such as a static random-access memory (abbreviation: SRAM), a double data rate synchronous dynamic random access memory (abbreviation: DDR SDRAM), etc.; the memory may also include a non-volatile memory, such as a flash memory. The memory 902 is used to store computer programs (such as application programs, functional modules, etc., for implementing the above mentioned method), computer instructions, etc., and the computer programs, computer instructions, etc., can be stored in one or more memories 902 by partitions. And the above-mentioned computer programs, computer instructions, data, etc., can be called by the processor 901.

The computer programs, computer instructions, etc., can be stored in one or more memories 902 by partitions. And the above-mentioned computer programs, computer instructions and data, etc., can be called by the processor 901.

The processor 901 is used for executing the computer program stored in the memory 902 to implement the steps in the method related to the above embodiment.

For details, reference can be made to related description in the above method embodiments.

The processor 901 and the memory 902 may be independent structures or integrated structures. When the processor 901 and the memory 902 are independent structures, the memory 902 and the processor 901 can be coupled by a bus 903.

The electronic device of the present embodiment can implement the technical solution in the above method, and its specific implementation process and technical principle are the same, which will not be repeated here.

In the technical solution of the present disclosure, the collection, storage, use, processing, transmission, provision and disclosure of personal information of users are all in line with the provisions of relevant laws and regulations, and do not violate public order and good customs.

According to an embodiment of the present disclosure, the present disclosure further provides an electronic device, a readable storage medium and a computer program product.

According to an embodiment of the present disclosure, the present disclosure further provides a computer program product, and the computer program product includes: a computer program stored in a readable storage medium, where at least one processor of an electronic device can read the computer program from the readable storage medium, and the at least one processor executes the computer program to cause the electronic device to execute the solution provided by any one of the embodiments above.

FIG. 10 shows a schematic block diagram of an exemplary electronic device 1000 that can be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device can also represent various forms of mobile apparatuses, such as personal digital assistants, cellular phones, smart phones, wearable devices and other similar computing apparatuses. The components shown herein, their connections and relationships, and their functions are only taken as examples, and are not intended to limit the implementation of the present disclosure described and/or claimed herein.

As shown in FIG. 10, the device 1000 includes a computing unit 1001, which can perform various appropriate actions and processes according to a computer program stored in a read only memory (ROM) 1002 or a computer program loaded from a storage unit 1008 into a random access memory (RAM) 1003. In the RAM 1003, various programs and data required for the operation of the device 1000 can also be stored. The computing unit 1001, the ROM 1002, and the RAM 1003 are connected to each other through a bus 1004. An input/output (I/O) interface 1005 is also connected to the bus 1004.

A number of components in the device 1000 are connected to the I/O interface 1005, including: an input unit 1006, such as a keyboard, a mouse, etc.; an output unit 1007, such as various types of displays, speakers, etc.; a storage unit 1008, such as a magnetic disk, an optical disk, etc.; and a communication unit 1009, such as a network card, a modem, a wireless communication transceiver, etc. The communication unit 1009 allows the device 1000 to exchange information/data with other devices through a computer network such as the Internet and/or various telecommunication networks.

The computing unit 1001 can be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, micro-controller, etc. The computing unit 1001 executes the various methods and processes described above, such as the training method of the text recognition model and the text recognition method. For example, in some embodiments, the training method of the text recognition model and the text recognition method can be implemented as a computer software program, which is tangibly contained in a machine-readable medium, such as the storage unit 1008. In some embodiments, part or all of the computer program can be loaded and/or installed on the device 1000 via the ROM 1002 and/or the communication unit 1009. When the computer program is loaded into the RAM 1003 and executed by the computing unit 1001, one or more steps of the training method of the text recognition model and the text recognition method described above can be executed. Alternatively, in other embodiments, the computing unit 1001 may be configured to execute the training method of the text recognition model and the text recognition method by any other suitable means (for example, by means of firmware).

The various embodiments of the systems and technologies described above can be implemented in digital electronic circuit systems, integrated circuit systems, field programmable gate arrays (FPGA), application specific integrated circuits (ASIC), application specific standard products (ASSP), system-on-chip (SOC), complex programmable logic devices (CPLD), computer hardware, firmware, software, and/or their combinations. These various implementations may include: being implemented in one or more computer programs that can be executed and/or interpreted on a programmable system including at least one programmable processor, which can be a special-purpose or general-purpose programmable processor that can receive data and instructions from and transmit data and instructions to a storage system, at least one input device, and at least one output device.

The program code for implementing the method of the present disclosure can be written in any combination of one or more programming languages. These program codes may be provided to the processors or controllers of general-purpose computers, special-purpose computers or other programmable data processing devices, so that when executed by the processors or controllers, the program codes cause the functions/operations specified in the flowcharts and/or block diagrams to be implemented. The program can be completely executed on the machine, partially executed on the machine, partially executed on the machine as an independent software package, partially executed on a remote machine or completely executed on a remote machine or server.

In the context of the present disclosure, a machine-readable medium may be a tangible medium that can contain or store a program for use by or in connection with an instruction execution system, apparatus or device. The machine-readable medium may be a machine-readable signal medium or a machine-readable storage medium. The machine-readable medium can include, but is not limited to, an electronic, magnetic, optical, electromagnetic, infrared, or semiconductor system, apparatus or device, or any suitable combination of the above. More specific examples of the machine-readable storage medium will include an electrical connection based on one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any suitable combination of the above.

To provide interaction with users, the systems and technologies described herein can be implemented on a computer, which has a display device (for example, CRT (cathode ray tube) or LCD (liquid crystal display) monitor) for displaying information to users; and a keyboard and a pointing device (for example, a mouse or a trackball) through which a user can provide input to a computer. Other kinds of devices can also be used to provide interaction with users; for example, the feedback provided to the user can be any form of sensory feedback (e.g., visual feedback, auditory feedback, or tactile feedback); and the input from the user can be received in any form (including acoustic input, voice input or tactile input).

The systems and technologies described herein can be implemented in a computing system including a back-end component (e.g., as a data server), a computing system including a middleware component (e.g., an application server), or a computing system including a front-end component (e.g., a user computer with a graphical user interface or a web browser through which users can interact with the embodiments of the systems and technologies described herein), or a computing system including any combination of such back-end components, middleware components, or front-end components. The components of the system can be connected to each other by digital data communication in any form or medium (e.g., communication network). Examples of the communication network include: a local area network (LAN), a wide area network (WAN) and the Internet.

The computer system may include a client and a server. The client and the server are generally remote from each other and generally interact through the communication network. The relationship between the client and the server is generated by computer programs running on corresponding computers and having a client-server relationship with each other. The server can be a cloud server, also known as cloud computing server or cloud host, which is a host product in the cloud computing service system, so as to solve the shortcomings of traditional physical host and VPS service (“Virtual Private Server”, or “VPS” for short), such as difficult management and weak business scalability. The server can also be a distributed system server or a server combined with block chain.

It should be understood that steps can be reordered, added, or deleted using the various forms of processes shown above. For example, the steps described in the present disclosure can be executed in parallel, sequentially or in different orders, so long as the desired results of the technical solutions disclosed in the present disclosure can be achieved, which is not limited herein.

The above specific embodiments do not limit the scope of protection of the present disclosure. Those skilled in the art should understand that various modifications, combinations, sub-combinations and substitutions can be made according to design requirements and other factors. Any modification, equivalent substitution and improvement made within the spirit and principle of the present disclosure shall be included in the scope of protection of the present disclosure.

What is claimed is:

1. A training method of a text recognition model, comprising:
performing mask prediction on visual features of an acquired sample image to obtain a predicted visual feature, and performing mask prediction on semantic features of acquired sample text to obtain a predicted semantic feature, wherein the sample image comprises text;
determining a first loss value of the text of the sample image according to the predicted visual feature, and determining a second loss value of the sample text according to the predicted semantic feature; and
training, according to the first loss value and the second loss value, to obtain the text recognition model, wherein the text recognition model is used to perform text recognition on at least one of text to be recognized and an image to be recognized.

2. The method according to claim 1, wherein the determining, according to the predicted visual feature, the first loss value of the text of the sample image comprises:
performing decoding processing on the predicted visual feature to obtain a predicted text character corresponding to the predicted visual feature; and
determining the first loss value according to the predicted text character corresponding to the predicted visual feature.

3. The method according to claim 2, wherein the determining the first loss value according to the predicted text character corresponding to the predicted visual feature comprises:
acquiring a marked text character of the sample image; and
calculating, according to the predicted text character corresponding to the predicted visual feature and the marked text character of the sample image, to obtain the first loss value.

4. The method according to claim 1, wherein the determining the second loss value of the sample text according to the predicted semantic feature comprises:
performing decoding processing on the predicted semantic feature to obtain a predicted text character corresponding to the predicted semantic feature; and
determining the second loss value according to the predicted text character corresponding to the predicted semantic feature.

5. The method according to claim 4, wherein the determining the second loss value according to the predicted text character corresponding to the predicted semantic feature comprises:
acquiring a marked text character of the sample text; and
calculating, according to the predicted text character corresponding to the predicted semantic feature and the marked text character of the sample text, to obtain the second loss value.

6. The method according to claim 1, wherein the training, according to the first loss value and the second loss value, to obtain the text recognition model comprises:
determining an average value of the first loss value and the second loss value, and training, according to the average value, to obtain the text recognition model.

7. The method according to claim 1, wherein the method is applied to a preset basic network, and the basic network comprises a context enhancing module and a decoding module;
the predicted visual feature is obtained by performing mask prediction on the visual features of the sample image based on the context enhancing module;
the first loss value is determined based on the predicted visual feature and the decoding module; and
the text recognition model is obtained by adjusting a parameter of the basic network based on the first loss value and the second loss value.

8. The method according to claim 1, wherein the method is applied to a preset basic network, and the basic network comprises a context enhancing module and an decoding module;
the predicted semantic feature is obtained by performing mask prediction on the semantic features of the sample text based on the context enhancing module;
the second loss value is obtained based on the predicted semantic feature and the decoding module; and
the text recognition model is obtained by adjusting a parameter of the basic network based on the first loss value and the second loss value.

9. The method according to claim 1, wherein before the performing mask prediction on the visual features of the acquired sample image to obtain the predicted visual feature, the method further comprises:
inputting the acquired sample image into an encoding module of a preset basic network, and outputting the visual features; and
the training, according to the first loss value and the second loss value, to obtain the text recognition model comprises:
adjusting a parameter of the encoding module according to the first loss value and the second loss value, to obtain the text recognition model.

10. The method according to claim 1, wherein before the performing mask prediction on the semantic features of the acquired sample text to obtain the predicted semantic feature, the method further comprises:
inputting the acquired sample text into a text embedding module of a preset basic network, and outputting the semantic features; and
the training, according to the first loss value and the second loss value, to obtain the text recognition model comprises:
adjusting a parameter of the text embedding module according to the first loss value and the second loss value, to obtain the text recognition model.

11. A text recognition method, comprising:
acquiring an object to be recognized, wherein the object to be recognized comprises text, and the object to be recognized is an image to be recognized or text to be recognized; and
performing text recognition on the object to be recognized based on a pre-trained text recognition model, to obtain text content corresponding to the object to be recognized;
wherein the text recognition model is obtained based on the method according to claim 1.

12. The method according to claim 11, wherein the object to be recognized is the image to be recognized, and the performing text recognition on the object to be recognized based on the pre-trained text recognition model, to obtain text content corresponding to the object to be recognized comprises:
performing feature-extraction processing on the image to be recognized, to obtain visual features of the image to be recognized; and
performing, by adopting the text recognition model, text recognition on the image to be recognized according to the visual features of the image to be recognized, to obtain text content corresponding to the image to be recognized.

13. The method according to claim 11, wherein the object to be recognized is the text to be recognized, and the performing text recognition on the object to be recognized based on the pre-trained text recognition model, to obtain text content corresponding to the object to be recognized comprises:
performing feature-extraction processing on the text to be recognized, to obtain semantic features of the text to be recognized; and
performing, by adopting the text recognition model, text recognition on the text to be recognized according to the semantic features of the text to be recognized, to obtain text content corresponding to the text to be recognized.

14. A training apparatus of a text recognition model, comprising:
at least one processor; and
a memory communicatively connected to the at least one processor; wherein
the memory stores an instruction executable by the at least one processor, and the instruction, when executed by the at least one processor, causes the at least one processor to:
perform mask prediction on visual features of an acquired sample image to obtain a predicted visual feature, wherein the sample image comprises text;
perform mask prediction on semantic features of acquired sample text to obtain a predicted semantic feature;
determine a first loss value of the text of the sample image according to the predicted visual feature;
determine a second loss value of the sample text according to the predicted semantic feature; and
train, according to the first loss value and the second loss value, to obtain the text recognition model, wherein the text recognition model is used to perform text recognition on at least one of text to be recognized and an image to be recognized.

15. The apparatus according to claim 14, wherein the processor is configured to:
perform decoding processing on the predicted visual feature to obtain a predicted text character corresponding to the predicted visual feature; and
determine the first loss value according to the predicted text character corresponding to the predicted visual feature.

16. The apparatus according to claim 15, wherein the processor is configured to:
acquire a marked text character of the sample image; and
calculate, according to the predicted text character corresponding to the predicted visual feature and the marked text character of the sample image, to obtain the first loss value.

17. The apparatus according to claim 14, wherein the processor is configured to:
perform decoding processing on the predicted semantic feature to obtain a predicted text character corresponding to the predicted semantic feature; and
determine the second loss value according to the predicted text character corresponding to the predicted semantic feature.

18. A text recognition apparatus, comprising:
at least one processor; and
a memory communicatively connected to the at least one processor; wherein
the memory stores an instruction executable by the at least one processor, and the instruction, when executed by the at least one processor, causes the at least one processor to execute the method according to claim 11.

19. A non-transitory computer-readable storage medium storing a computer instruction, wherein the computer instruction is used to cause a computer to execute the method according to claim 1.

20. A non-transitory computer-readable storage medium storing a computer instruction, wherein the computer instruction is used to cause a computer to execute the method according to claim 11.
